(19) United States
(12) Patent Application Publication
(10) Pub. No.: US 2010/0200618 A1
(43) Pub. Date: Aug. 12, 2010

(54) CLOSURE FOR THE METERED DISPENSING OF ADHESIVE FROM A CONTAINER

(75) Inventor: Werner F. Dubach, Maur (CH)

Correspondence Address: SPECKMAN LAW GROUP PLLC, 1201 THIRD AVENUE, SUITE 330, SEATTLE, WA, 98101, US

(73) Assignee: KISLING AG, Tagelswangen (CH)

(21) Appl. No.: 12/671,201

(22) PCT Filed: Jul. 3, 2008
(86) PCT No.: PCT/CH2008/000301

§ 371 Date: Jan. 28, 2010

(30) Foreign Application Priority Data
Aug. 2, 2007 (CH) 1228/07
Jul. 3, 2008 (CH) PCT/CH2008/000301

(51) Int. Cl. B67D 3/00; B23P 17/04

(52) U.S. Cl. 222/521; 29/428

(57) ABSTRACT

In order to manufacture a closure having an improved seal and lower degree of wear at more reasonable cost, a closure is proposed, the closure comprising an upper part (5), a lower part (4) and a conveying sleeve (6) with a sealing pin (65). On the lower part (4) there are two concentric, upwardly directed annular walls (48) which interact under prestress with two corresponding, concentrically downwardly directed annular walls (500) on the upper part (5), which annular walls are directed downwards. The lower part (4) and the conveying sleeve (6) can be manufactured integrally via predetermined breaking point bridges (600), thus making it possible to obtain a cost-saving method of assembly.

The present invention pertains to a closure for the metered dispensing of adhesive from a container according to the preamble of Claim 1, to a semi-finished product for the manufacture of the closure according to Claim 1, and to a method for manufacturing the closure according to Claim 1 by utilizing a semi-finished product according to Claim 9.

The storage and the metered dispensing of adhesives such as cyanoacrylates, instant adhesives or anaerobic adhesives and sealants are extremely problematic. Depending on the type of adhesive, it either hardens when it is exposed to oxygen or, in case of anaerobic adhesives and sealants, when it is exposed to humidity. In order to prevent this hardening, EP-B-0 899 211 already proposed a container that is realized in a double-walled fashion from top to bottom, as well as on the bottom itself, so as to largely prevent the admission of oxygen. A matching plastic closure is described, for example, in CH-A-693 064. In this sealing pin closure, the sealing pin is rigidly moulded on the opening of the container and the closure itself is realized in one piece and screwed on the neck of the container. The one-piece closure features a jacket wall that is provided with an internal thread such that it can be attached to the container neck with an external thread. The jacket wall is followed by a peripheral shoulder that is adjoined by a sleeve-shaped part transforming into an outlet nozzle, into which the sealing pin engages in a sealing fashion in the closed position. The opening of the container neck upwardly extends as far as the sleeve-shaped structure in the closed state. When the closure is opened and closed, the upper edge of the container neck acts as a sliding seal relative to the sleeve-shaped structure of the closure.

With respect to the manufacturing technology, the sleeve-shaped structure requires a certain conicality in order to be removed from the mould at all. This means that the widest section of the sleeve-shaped structure is situated in the region of the shoulder and the narrowest section is situated on top in the direction toward the outlet nozzle. Consequently, the region of the sleeve-shaped structure comes in contact with the adhesive, wherein various adhesives of this type are extremely aggressive and slightly dissolve the surface of different plastics, particularly also plastics that are suitable for the manufacture of the closure. Frequent use therefore may render the seal in the sleeve-shaped structure ineffective. Furthermore, such a closure and the corresponding container neck need to be manufactured with extreme dimensional accuracy in order to achieve a sufficiently tight seal, wherein this extreme dimensional accuracy results in a relatively high reject quota. In addition, the dimensional accuracy of such closures and containers needs to be checked during the manufacture in order to prevent defective batches, in which the adhesive hardens in the container.

The design and the arrangement of the seals require the utmost attention in order to manage these problems.

A multi-part closure according to the preamble of Claim 1 is known from DE-A-1 536 129. This document describes different closures, some of which consist of several parts and feature a separate conveying sleeve. However, they are not designed for adhesives and therefore do not meet the requirements with respect to the tightness required for adhesives for various reasons. Practically all embodiments feature, in particular, two seals that are arranged one below the other in the conical region of the conveying sleeve, wherein the bottom seal may, as mentioned above, practically still be impervious to liquids, but certainly no longer air-tight due to the aforementioned conicality. In all solutions to be considered, an inner seal is always situated between the sleeve-shaped structure and a cylindrical wall that surrounds the sleeve-shaped structure. The bottom seal is situated on the bottom of the cylindrical structure and in the lower region of the concentrically surrounding wall that, as mentioned above, needs to have a certain conicality. This conicality is realized differently depending on the model. In addition, certain embodiments feature a sealing pin that is rigidly connected to the lower part or even to the container neck itself as shown in FIG. 9.

Consequently, the present invention is based on the objective of developing a closure, in which the sealing surfaces tightly adjoin one another under prestress such that the aforementioned problems can be avoided.

Another objective of the present invention consists of realizing a closure of this type such that it can be manufactured as easily and cost-efficiently as possible.

The invention furthermore aims to disclose an assembly method, by means of which an inventive closure can be assembled as easily and inexpensively as possible.

The first objective is attained with a closure with the characteristics of Claim 1. Such a closure can be manufactured as easily and cost-efficiently as possible by utilizing a semi-finished product with the characteristics of Claim 9.

When utilizing a semi-finished product according to Claim 9, the inventive closure according to Claim 1 can be assembled as easily and cost-efficiently as possible with the method according to Claim 13.

Other advantages of the invention are disclosed in the dependent claims, wherein the corresponding designs and functions are described below with reference to the attached drawings.

The drawings show only one preferred embodiment of the object of the invention.

In these drawings:

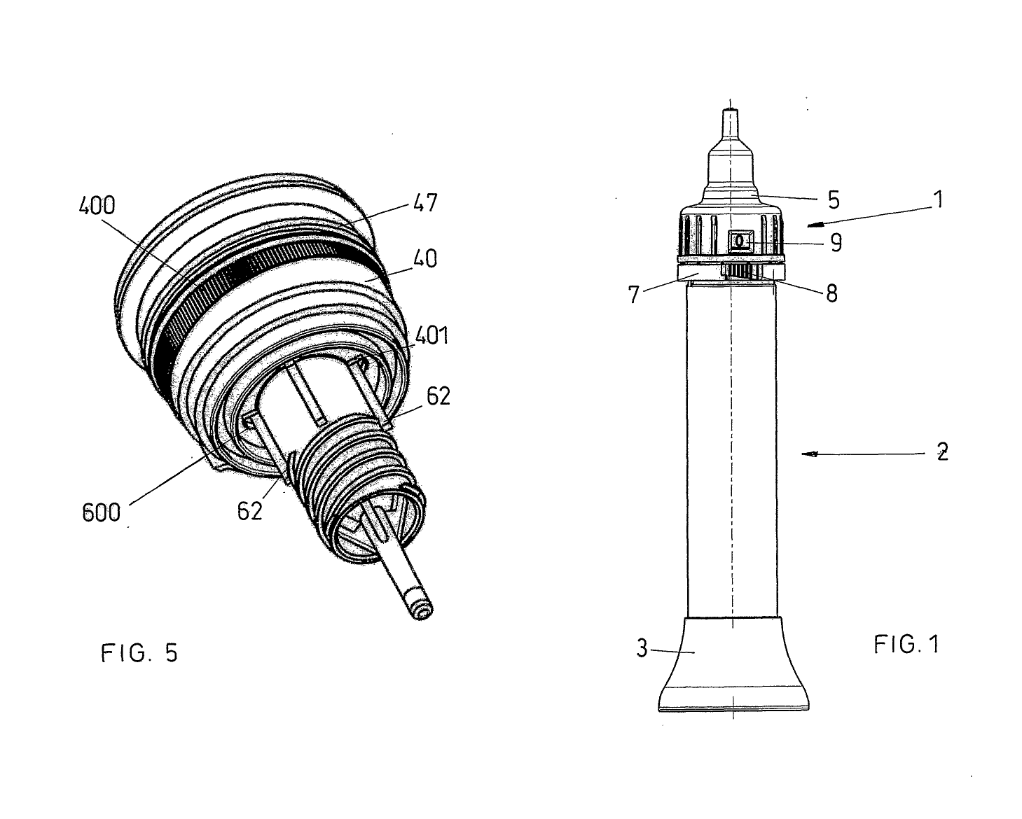

FIG. 1 shows an adhesive container with attached closure in the form of a side view;

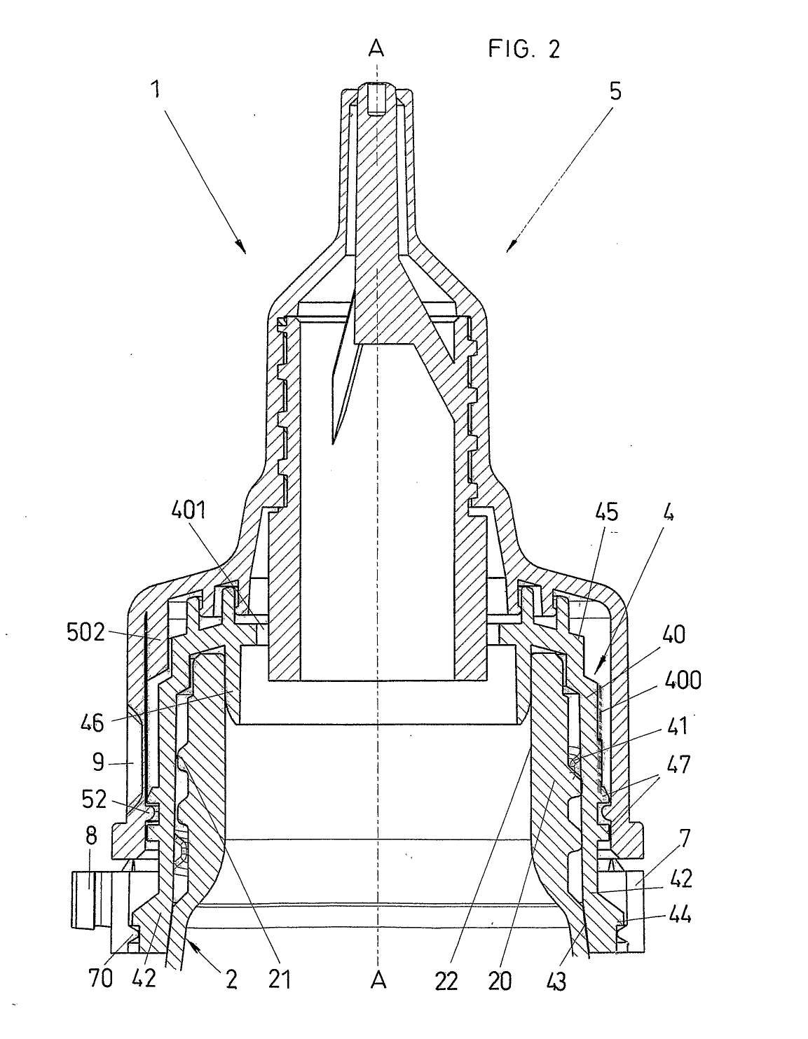

FIG. 2 shows the closure in the attached state in the form of a vertical section;

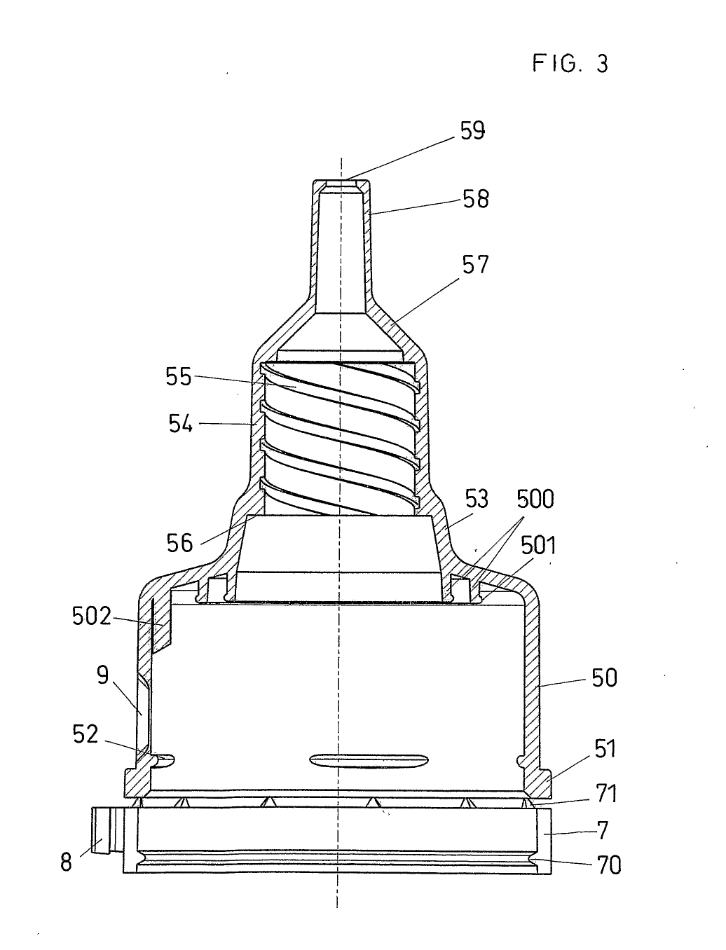

FIG. 3 shows the upper part of the closure according to FIG. 2 in the form of a vertical diametric section;

FIG. 4 shows the lower part and the corresponding conveying sleeve as a semi-finished product, namely also in the form of a diametrically and vertically sectioned representation, and

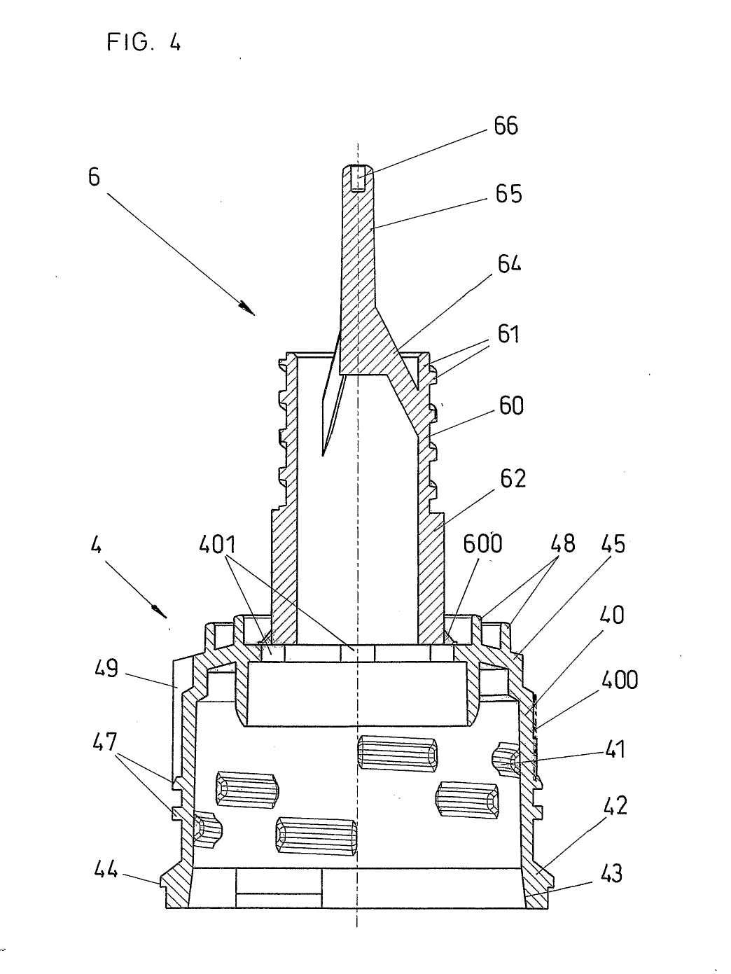

FIG. 5 shows the semi-finished product according to FIG. 4 in the form of a perspective representation.

FIG. 1 shows the inventive closure that is identified as a whole by the reference symbol 1 and attached to a container 2 that features a base 3. A mechanism that simplifies the dispensing of the contents from the container 2 may be moulded on the base 3. However, this is not the object of the invention and therefore not illustrated.

In this illustration, practically only the upper part 5 of the closure 1 to be described in detail further below is visible. A tamper-proofing band 7 is moulded on the bottom of the upper part 5 in order to ensure that the closure has not been opened yet. Consequently, the tamper-proofing band needs to be removed prior to the initial opening of the container, wherein the tamper-proofing band is provided with a tear-off tab 8 for this purpose. A window 9 is also shown in this illustration, wherein a scale that is visible through this window indicates how far the closure 1 is opened. Since the closure 1 is completely closed in the present instance, a zero is shown on the scale.

In FIG. 2, the inventive closure is illustrated in the assembled state prior to the initial opening of the container, namely in the form of a vertical diametric section. The broken line A-A defines the center line of the closure. Only the container neck 20 of the container 2 is visible in this illustration. The container neck 20 is provided with an external thread 21, on which the lower part 4 is screwed with the aid of an internal thread provided on the lower part. At its outlet 22, the container neck 20 is sealed by means of a sealing olive. The lower part 4 features a jacket wall 40 that is provided with the aforementioned internal thread 41. The lower edge of the jacket wall 40 features a thickening 42 with a conically inclined inner surface 43 that adjoins the shoulder of the container 2 in a sealing and clamping fashion when the lower part 4 is attached to the container 2. A retaining bead 44 is moulded on the outer side of the thickening, wherein retaining lobes 70 or a peripheral retaining bead of the tamper-proofing band 7 according to FIG. 3 respectively engage or engages behind said retaining bead. The tear-off tab 8 is also visible on one side.

On the upper edge, the jacket wall 40 of the lower part 4 transforms into a first shoulder 45 that forms an annular surface, wherein this annular surface partially extends toward the center line A-A. The aforementioned sealing olive 46 that seals the lower part 4 relative to the container 2 is moulded on the bottom of this first shoulder 45. Two annular beads 47 on the outer side of the jacket wall 40 serve for guiding the upper part 5.

Two concentric annular walls 48 are moulded on the aforementioned first shoulder 45 of the lower part 2 such that they are directed vertically upward. This is illustrated most clearly in FIG. 4, in which only the lower part 4 and the conveying sleeve 6 are illustrated. In this figure, these two components are illustrated in one piece as described in detail further below. Otherwise, all previously described elements of the lower part 4 are also illustrated in this figure, wherein a stopping rib 49, the importance and function of which are described further below, is moulded on the jacket wall 40 and protrudes radially outward. This stopping rib 49 extends from the first shoulder 45 to the upper annular bead of the two annular beads 47. A scale 400 is arranged in the region between the upper annular bead 47 and the first shoulder 45 of the lower part 2, wherein this scale naturally is not visible in the section, but indicated on the right side in the drawing. In this respect, we refer to above-described FIG. 1, as well as to FIG. 5 that is described in detail further below. Outwardly directed notches 401 are illustrated in the annular surface of the first shoulder 45. Consequently, the first shoulder 45 or its surface respectively protrudes inward toward the center axis A-A with an extension that amounts to twice the depth of the notches 401.

The closure 1 furthermore comprises a conveying sleeve 6 that is completely separated from the remaining parts of the closure 1 in the assembled state thereof. This is illustrated in FIG. 2. However, the description of this conveying sleeve 6 refers to FIG. 4 rather than to FIG. 2. The conveying sleeve 6 features a cylindrical jacket wall 60 that is provided with an external thread 61 in the upper region. Consequently, the conveying sleeve 6 forms a tube that is open on both sides. A number of guide ribs 62 is moulded on the outer side of the cylindrical jacket wall 60 below the thread 61, wherein four guide ribs are provided in the example shown. These guide ribs 62 axially extend over practically half the length of the cylindrical jacket wall 60, namely from the region below the external thread 61 to the lower edge. Several supports 64 that are obliquely directed from the outside toward the inside and toward the top are moulded on the inner surface 63 of the cylindrical jacket wall 60 in the upper region thereof, wherein these supports carry the actual sealing pin 65. This sealing pin 65 has a certain conicality and features a depression 66 on its outer tip.

The width of the guide ribs 62 is adapted to the width of the notches 401, wherein said notches are arranged in the wall region of the first shoulder 45 that extends radially inward as mentioned above.

The upper part 5 of the closure 1 is illustrated separately in FIG. 3 in the form of a vertical diametric section through its center. The upper part 5 features a peripheral jacket wall 50, wherein a thickening 51 is moulded on the lower edge of said jacket wall and the aforementioned tamper-proofing band 7 with its tear-off tab 8 is arranged flush underneath said thickening. The tamper-proofing band 7 is connected to the jacket wall 50 by means of predetermined braking points 71. Elongated lobes 52 are moulded on the inner side of the jacket wall 50 above the thickening 51, wherein said lobes engage between the two annular beads 47 on the lower part in the assembled state of the closure. Due to this measure, the upper part 5 is axially secured and rotatably guided relative to the lower part 4. The window 9 arranged in the jacket wall 50 is also illustrated in the figure.

On its upper end, the jacket wall 50 transforms into a second shoulder 53 that slightly extends obliquely upward toward the center. This second shoulder 53 transforms into a sleeve-shaped attachment 54. The sleeve-shaped attachment 54 features an internal thread 55 on its inner side. This internal thread 55 is realized such that it matches the external thread 61 of the above-described conveying sleeve 6. A plane annular stop or a stopping face 56 is situated in the region, in which the sleeve-shaped attachment 54 transforms into the shoulder 53. A funnel-shaped section 57 that ultimately opens into a discharge nozzle 58 is situated above the cylindrical part of the sleeve-shaped attachment 54. The very top of the outlet nozzle 58 ends in an outlet openings 59.

On its underside, the second shoulder 53 features two concentric annular walls 500 that are directed downward. These concentric annular walls 500 are arranged in such a way that their outer lateral surfaces extend approximately in alignment with the inner lateral surfaces of the concentric annular walls 48 of the lower part 4 in the assembled state of the closure. Outwardly directed annular beads 501 are moulded on the lower ends of these concentric annular walls 500. The thickness of these annular beads 501 defines the preload, with which the annular walls 500 adjoin the concentric annular walls 48 of the lower part. This arrangement naturally could also be reversed such that the concentric annular walls on the upper part are realized without annular beads 501 and the concentric rings 48 on the lower part 4 are realized with inwardly directed annular beads on their upper ends.

The underside of the shoulder 53 is also provided with a stopping element 502 that practically adjoins the jacket wall 50 directly. This stopping element 502 naturally may also be moulded on the jacket wall 50 in this region. In the assembled state of the closure 1, this stopping element 502 cooperates with the stopping rib 49 of the lower part and not only defines the completely closed state of the closure in the stopping position, but also the stop for the maximum opening position, in which the sealing pin 65 is situated in its lowest position, when it is turned by 360°.

FIG. 4 shows the inventive semi-finished product consisting of the lower part 4 and the conveying sleeve 6. In the semi-finished state, these two components are connected to one another by means of predetermined breaking point bridges 600. These predetermined breaking point bridges 600 form a connection between the guide ribs 62 and the first shoulder 45 of the lower part 4, namely in the region of the edge of the notches 401 that is situated farthest toward the outside referred to the center. This arrangement is particularly sensible because the largest clearance between the conveying sleeve 6 and the lower part 4 may occur in this direction and at this location. Consequently, remnants that may remain on the two components after the separation do not have any negative effects.

The advantage of the inventive semi-finished product primarily can be seen in that one less injection mould is required such that no additional injection moulding machine is needed for the manufacture. The additional costs for the slightly larger depth of the injection mould are negligible. The slightly longer cycle time per injection process is also negligible in comparison with the savings, particularly in light of the fact that the semi-finished product consisting of the lower part 4 and the conveying sleeve 6 does not require any additional surface on the injection mould. Since the semi-finished product is continuously tapered from the top to the bottom without exception, namely from the retaining bead 44 on the jacket wall 40 of the lower part 4 to the tip of the sealing pin 65 on the conveying sleeve 6, the semi-finished product can also be easily removed from the mould without a slide. The slight elevations that protrude outward, for example of the thread 61 or of the annular beads 47, are so small that the semi-finished product can be ripped out after the injection process without creating defects due to its elasticity. Another advantage of the semi-finished product can be seen in that the position of the conveying sleeve 6 relative to the lower part 4 is exactly defined in the radial direction such that a corresponding alignment of the components during the subsequent assembly is eliminated. In addition to this radial alignment of the two components 4 and 6, they also do not have to be axially aligned with one another. This significantly simplifies the subsequent assembly.

As initially mentioned, the invention also pertains to a method for assembling the inventive closure by utilizing the semi-finished product illustrated in FIG. 4.

In this inventive method, the two components, namely the upper part 5 and the conveying sleeve 6, are aligned with one another in the axial direction. In this aligned position, the center axis of the conveying sleeve 6 and the center axis of the sleeve-shaped attachment of the upper part 5 are in alignment. In this case, the upper part 5 is held by a gripper and a rotatable finger that features corresponding slots on its upper end is simultaneously inserted into the conveying sleeve or into the interior of this conveying sleeve 6, wherein said slots are realized in such a way that the supports 64 holding the rotary pin 65 positively fit into these slots. In this case, one normally proceeds in such a way that the finger is inserted and the conveying sleeve 6 is subsequently turned until the aforementioned supports 64 fall into the slots. The entire semi-finished product is now held in the correct position.

In the next step, the upper part 5 is moved toward the semi-finished product 4, 6 and its external thread 61 is screwed into the internal thread 55 of the sleeve-shaped attachment 54 of the upper part 5. This screw-on movement is continued until the guide ribs 62 on the conveying sleeve 6 contact the annular stopping face 56 underneath the internal thread 55. It is advantageous to monitor the torque during this screw-on movement in order to ensure an exact radial alignment of the conveying sleeve 6 relative to the upper part 5, as well as an exact alignment of the lower part 4 relative to the upper part 5, once a predetermined torque is reached.

As soon as this position is reached, a collision movement between the lower part 4 and the upper part 5 is carried out in order to destroy the predetermined breaking point bridges 600. The guide ribs 62 now slide downward through the notches 401 while the attached upper part with its concentric annular walls 500 simultaneously moves downward and slides down along the concentric walls 48 on the lower part 4 until the end position is reached. In this case, the aforementioned annular beads 501 cause the annular walls 500 to be slightly deformed inward while the annular walls 48 simultaneously are slightly deformed outward. The concentric annular walls 500 and 48 therefore adjoin one another under preload.

Due to the exact radial alignment, the stopping element 502 on the upper part 5 is also situated such that it at least approximately contacts the stopping rib 49 of the lower part 4 in this position. The closure 1 is in the completely closed state in this position as illustrated in FIG. 2. During this downward movement, the elongated lobes 52 simultaneously snap into the region between the two annular beads 47 on the lower part and the lobes 70 or, if applicable, the annular bead are/is pushed underneath the retaining bead 44 on the jacket wall 40 of the lower part 4.

Before the closure can be actuated, it is therefore required to take hold of the tear-off tab 8 and to tear off the tamper-proofing band 7. The upper part 5 can now be turned, wherein the now completely separated conveying sleeve 6 simultaneously moves downward such that the sealing pin 65 is downwardly displaced in the outlet nozzle 48. The adhesive can flow upward through the conveying sleeve 6 and flows around the sealing pin 65 before it is ultimately discharged from the outlet opening 59.

Since a practically air-tight connection toward the outside is realized with the prestress of the aforementioned concentric walls, adhesive can hardly be admitted into the region of the thusly formed concentric annular seals on the outer surface of the conveying sleeve 6. Even if a small quantity of adhesive is admitted into this region, this only affects the inner of the two annular seals and may cause wear under certain circumstances. However, the outer of the two annular seals remains intact. The surface dissolution phenomenon therefore can only have a minimal effect on the inner annular seal in the worst case scenario.

FIG. 5 shows the semi-finished product consisting of the lower part 4 and the conveying sleeve 6 in the form of a 3-dimensional drawing. This drawing clearly shows the guide ribs that are not illustrated as clearly in the sectional representation according to FIG. 4. This drawing furthermore shows the notches 401. The nominal breaking points 600 are also visible. However, FIG. 5 also serves, in particular, for illustrating the scale 400 that is arranged on the outer side of the jacket wall 40 above the two annular beads 47. This scale may, in principle, be realized arbitrarily. In the present example, it is realized in the form of a band of ribbings that is visible through the aforementioned window 9. The further the closure is opened, the wider this band becomes. In the completely closed state, the band is no longer visible and the number 0 appears as illustrated in FIG. 1. In this case, the scale naturally is also automatically arranged at the correct location because the scale 400 is attached by means of injection moulding and consequently always arranged at a predetermined position relative to the stopping rib 49. This ensures that the number 0 appears after the assembly when the completely closed position is reached, and that the aforementioned number 0 is also shown through the window 9. Such a scale is particularly sensible in connection with the described adhesives because they act particularly fast and well if the applied layer is as thin as possible. Until now, such a control option was not provided on closures of this type with a sealing pin.

Consequently, the invention proposes a closure 1 that is optimally designed for its use, has excellent sealing properties and can be cost-efficiently manufactured by utilizing a semi-finished product according to FIG. 4, wherein the closure can be assembled in an equally cost-efficient fashion as described above.

### LIST OF REFERENCE SYMBOLS

1 Closure
2 Container
3 Base
4 Lower part
5 Upper part
6 Conveying sleeve
7 Tamper-proofing band
8 Tear-off tab
9 Window
20 Container neck
21 External thread
22 Outlet
40 Jacket wall
41 Internal thread
42 Thickening
43 Conically inclined inner surface
44 Retaining bead
45 First shoulder
47 Annular beads
48 Concentric annular walls
49 Stopping rib
400 Scale
401 Notches
50 Jacket wall
51 Thickening
52 Elongated lobes
53 Second shoulder
54 Sleeve-shaped attachment
55 Internal thread
56 Plane annular stop
57 Funnel-shaped section
58 Outlet nozzle
59 Outlet opening
500 Annular walls
501 Annular beads
502 Stopping element
60 Cylindrical jacket wall
61 External thread
62 Guide rib
63 Inner surface
64 Supports
65 Sealing pin
66 Depression
600 Predetermined breaking point bridges
70 Lobes
71 Predetermined breaking point bridges

1. A closure for the metered dispensing of adhesive from a container, wherein the closure comprises:
(a) a lower part that can be attached to the container in a sealing fashion and having a peripheral jacket wall transforming into a first annular shoulder that is directed toward the center,
(b) an upper part that forms a cap that is rotatably held on the lower part and having a jacket wall, the top of which is provided with a second annular shoulder that is directed toward the center and centrally tapered such that an outlet nozzle is formed, and
(c) a conveying sleeve with a central sealing pin that is separated from the lower part and the upper part in the assembled state, wherein said conveying sleeve is supported in the lower part in a sliding and non-rotatable fashion and moves in an internal thread in the upper part such that the sealing pin can be transferred from an upper closed position into a lower open position and vice versa by turning the upper part in the outlet nozzle,
wherein two concentric, outwardly directed annular walls are arranged on the first shoulder of the lower part, and two concentric annular walls are arranged on the upper part such that they are directed downward on the underside of the second shoulder, and wherein pairs of the concentric walls respectively form sliding seals that adjoin one another under preload.

2. The closure according to claim 1, wherein the ends of the concentric annular walls on the upper part have peripheral annular beads that are directed outward and adjoin the lower part under preload on the inner sides of the concentric annular walls.

3. The closure according to claim 1, wherein the concentric annular walls on the lower part have inwardly protruding annular beads that adjoin the upper part under prestress on the outer side of the concentric annular walls.

4. The closure according to claim 3, wherein the preload is generated due to the thickness of the annular beads.

5. The closure according to claim 1, wherein the upper region of the conveying sleeve has an external thread that cooperates with an internal thread arranged in a sleeve-shaped attachment between the second shoulder of the upper part and the outlet nozzle.

6. The closure according to claim 5, wherein at least two guide ribs are moulded on the conveying sleeve underneath the external thread such that they protrude radially outward, and the first shoulder has notches, in which the at least two guide ribs are positively supported in a sliding fashion in order to prevent a rotation thereof.

7. The closure according to claim 1, wherein the sealing pin is held in the conveying sleeve by means of supports that extend from the inner wall of the conveying sleeve to the center.

8. The closure according to claim 6, wherein the sleeve-shaped attachment has a plane, annular stop underneath the internal thread, and the guide ribs contact the stop in the closed state of the closure.

9. A semi-finished product for manufacturing a closure according to claim 1, wherein the semi-finished product consists of the lower part and the conveying sleeve, and the lower part and the conveying sleeve are manufactured in one piece and connected by means of predetermined breaking point bridges.

10. The semi-finished product according to claim 9, wherein the upper region of the conveying sleeve features an external thread and at least two guide ribs are moulded on the conveying sleeve such that they protrude radially outward, and the first shoulder has notches that are adapted to the cross-sectional shape of the at least two guide ribs, and wherein the predetermined breaking point bridges are moulded on the lower edge of the guide ribs on one side and on the edge of the notches on the other side.

11. The semi-finished product according to claim 9, wherein a stopping rib that protrudes radially outward is moulded on the outer side of the jacket wall of the lower part, wherein a stopping element is injection-moulded on the inner side of the upper part, and wherein the stopping rib and the stopping element jointly limit the rotation between the upper part and the lower part in an assembled state of the closure.

12. The semi-finished product according to claim 11, wherein a window is arranged in the jacket wall of the upper part in a predetermined angular position to the stopping element, and wherein a scale is arranged on the lower part and indicates the rotation of the upper part relative to the lower part in relation to the position, in which the stopping rib and the stopping element are in contact with one another in the assembled state.

13. An assembly method for manufacturing a closure according to claim 1 using a semi-finished product consisting of the lower part and the conveying sleeve, the lower part and the conveying sleeve being manufactured in one piece and connected by means of predetermined breaking point bridges, wherein the upper part features a sleeve-shaped attachment (54) between the second shoulder and an outlet nozzle, wherein the center axis of the semi-finished product with its conveying sleeve is axially aligned with the center axis of the attachment and the semi-finished product is then screwed into the sleeve-shaped attachment of the upper part until the guide ribs contact the conveying sleeve underneath the sleeve-shaped attachment, wherein the predetermined breaking point bridges are now separated due to a collision movement and the upper part with the conveying sleeve screwed into the sleeve-shaped attachment is pushed downward to such a degree that the concentric annular walls on the upper part and the lower part slide on one another under a certain prestress and are moved into a preloaded position.

14. The assembly method according to claim 13, wherein the upper part and the semi-finished product are screwed together with a predetermined torque and while monitoring said torque such that a stopping element on the upper part and a stopping rib on the lower part are moved into an approximately contacting position relative to one another after the collision movement once a predetermined torque is reached.

15. The assembly method according to claim 13, wherein the semi-finished product is attached to a rotatively driven holding finger before the semi-finished product and the upper part are screwed together.

16. The assembly method according to claim 15, wherein the holding finger has notches with such dimensions that supports holding the sealing pin of the conveying sleeve can be at least in part positively accommodated therein, wherein the semi-finished product is attached and the holding finger carries out a certain rotation while the semi-finished product is non-rotationally fixed, until the aforementioned supports engage into the notches of the holding finger.
